(19) United States
(12) Patent Application Publication
(10) Pub. No.: US 2020/0347667 A1
(43) Pub. Date: Nov. 5, 2020

(54) INSULATING PANEL ASSEMBLY

(71) Applicant: Oldcastle BuildingEnvelope Inc., Terrell, TX (US)

(72) Inventors: Billy Strait, McKinney, TX (US); Bob Gebert, Kronenwetter, WI (US); Jeff Geier, Weston, WI (US); Philip M. Benes, Wausau, WI (US); Richard Braunstein, Addison, TX (US); Rick Wright, Delran, NJ (US); Robert Williams, Somerdale, NJ (US); William J. Lang, Rockwall, TX (US)

(21) Appl. No.: 16/863,940

(22) Filed: Apr. 30, 2020

Related U.S. Application Data
(60) Provisional application No. 62/841,565, filed on May 1, 2019.

(51) Int. Cl. E06B 3/67; E06B 3/663

(52) U.S. Cl. CPC E06B 3/6715; E06B 2003/6638; E06B 3/66309

(57) ABSTRACT

An insulating panel assembly includes an exterior panel that is formed of a metal. The insulating panel assembly also includes an interior panel. A spacer is coupled to the exterior panel and the interior panel. The spacer maintains the exterior panel in a generally parallel, spaced relationship with the interior panel.

### CROSS-REFERENCE TO RELATED APPLICATIONS

The present application claims priority to, and incorporates by reference the entire disclosure of, U.S. Provisional Patent Application No. 62/841,565, filed on May 1, 2019.

### TECHNICAL FIELD

The present disclosure relates generally to architectural panels and more specifically, but not by way of limitation, to insulating panel assemblies having an exterior metal sheet.

### BACKGROUND

An insulated metal panel (“IMP”) is a common exterior feature of many structures. IMPs allow certain exterior building features to be substantially concealed while, at the same time, serve as a barrier to heat transfer through the IMP. IMPs are typically manufactured by laminating one or more metal sheets onto a generally-planar insulator. This production method requires that the edges of the IMP be treated following lamination to reduce the risk that the metal sheets delaminate from the insulator or to make the edge regions of the IMP aesthetically acceptable.

### SUMMARY

Aspects of the disclosure relate to an insulating panel assembly. The insulating panel assembly includes an exterior panel. The exterior panel is formed of a metal. An interior panel has a length equal to the exterior panel. A spacer is coupled to the exterior panel and the interior panel. The spacer maintains the exterior panel in a generally parallel, spaced relationship with the interior panel such that a gap is defined between the exterior panel and the interior panel.

Aspects of the disclosure relate to a method of manufacturing an insulating panel assembly. The method includes forming an exterior panel from a metal. An interior panel having a length equal to the exterior panel is formed. The exterior panel and the interior panel are coupled to a spacer such that a gap is defined between the exterior panel and the interior panel. The exterior panel and the interior panel are maintained in a generally parallel, spaced relationship.

### BRIEF DESCRIPTION OF THE DRAWINGS

For a more complete understanding of the present disclosure and for further objects and advantages thereof, reference may now be had to the following description taken in conjunction with the accompanying drawings in which:

FIG. 1 is an exterior perspective view of an insulating panel assembly in accordance with aspects of the disclosure;

FIG. 2 is an interior perspective view of the insulating panel assembly of FIG. 1 in accordance with aspects of the disclosure;

FIG. 3 is an exterior perspective view of an insulating panel assembly with insulation in accordance with aspects of the disclosure;

FIG. 4 is an interior perspective view of the insulating panel assembly of FIG. 3 in accordance with aspects of the disclosure;

FIG. 5 is a flow diagram illustrating a process for manufacturing an insulating panel assembly according to aspects of the disclosure; and

FIG. 6 is a flow diagram of a process for installing an insulated metal panel according to aspects of the disclosure.

### DETAILED DESCRIPTION

Various embodiments will now be described more fully with reference to the accompanying drawings. The disclosure may, however, be embodied in many different forms and should not be construed as limited to the embodiments set forth herein.

Currently, IMPs typically include at least one exterior panel that is laminated to an insulating material. In applications where the edges of such panels are exposed, the bond between the exterior panel and the insulating material can wear and become delaminated from the insulating material. Additionally, lamination often requires that the edges of the IMP be treated following lamination to reduce the risk that the metal sheets delaminate from the insulator or to make the edge regions of the IMP aesthetically acceptable. Further, IMPs often experience stresses caused by differing coefficients of thermal expansion between laminated layers of the IMP.

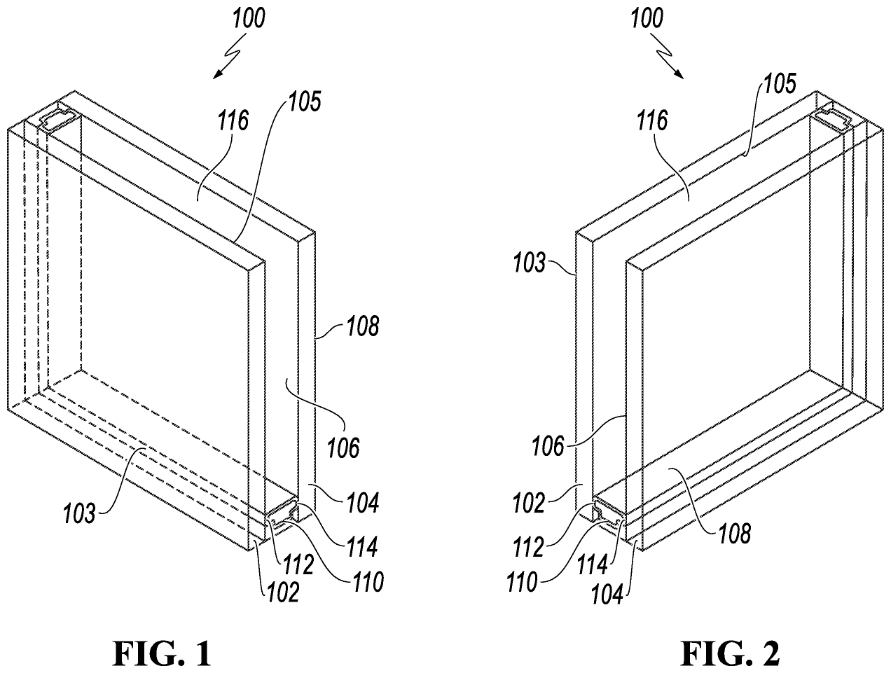

FIG. 1 is an exterior perspective view of an insulating panel assembly 100. FIG. 2 is an interior perspective view of the insulating panel assembly 100. Referring to FIGS. 1-2 collectively, the insulating panel assembly 100 includes an exterior panel 102 arranged on a building-exterior-facing side of the insulating panel assembly 100. The exterior panel 102 is arranged in a generally parallel, spaced relationship with an interior panel 104. The interior panel 104 is arranged on a building-interior-facing side of the insulating panel assembly 100. In various embodiments, the exterior panel 102 is a finished metal panel constructed of, for example, steel, aluminum, various alloys, painted steel, anodized stainless steel, or porcelain-enamel-coated steel. By way of example, the exterior panel 102 is illustrated herein as having a smooth exterior-facing surface 103 (commonly referred to as the “number 1 surface”). However, in other embodiments the exterior-facing surface 103 of the exterior panel 102 could include, for example, patterns or textures in an effort to achieve a desired building aesthetic appearance. In various embodiments, the interior panel 104 is, for example, a monolithic architectural glass panel; however, in other embodiments, the interior panel 104 could be constructed of, for example, laminated glass, patterned decorative glass, stone, or other impervious material. In other embodiments, the interior panel 104 could be constructed of, for example, a finished metal panel of the type described above with respect to the exterior panel 102. The interior panel 104 may, in various embodiments, include a low emissivity coating on either a first surface 106 of the interior panel 104 (commonly referred to as the “number 3 surface”) or a second surface 105 of the exterior panel 102 (commonly referred to as the “number 2 surface”). In various embodiments, however, the low emissivity coating may be applied to a second surface 108 of the interior panel 104 (commonly referred to as the “number 4 surface”).

Still referring to FIGS. 1-2, the exterior panel 102 and the interior panel 104 are maintained in a spaced relationship by a spacer 110. In various embodiments, the spacer 110 is constructed of a material such as, for example, aluminum, stainless steel, galvanized steel, or any other appropriate material. In other embodiments, the spacer 110 may be constructed of a material with a low thermal conductivity such as, for example, composite materials such as fiber-reinforced polymers, structural foam, plastic-hybrid stainless steel, or a thermally-broken aluminum assembly having a thermal plastic spacer. The spacer 110 includes a first attachment surface 112 and a second attachment surface 114 that is arranged generally parallel to the first attachment surface 112. In various embodiments, the first attachment surface 112 of the spacer 110 may be coupled to the exterior panel 102 and second attachment surface 114 of the spacer 110 may be coupled to the interior panel 104 via an adhesive applied to at least one of the exterior panel 102, the interior panel 104, and the spacer 110. In various embodiments, the adhesive may include multiple layers of, for example, polyisobutylene (PIB) and silicone. In other embodiments, the spacer 110 may be mechanically joined to the exterior panel 102 and the interior panel 104 by fasteners such as, for example, screws, bolts, rivets, or other similar fasteners. The spacer 110 creates a gap 116 between the exterior panel 102 and the interior panel 104. In various embodiments, the gap 116 may be of varying dimensions. For example, in various embodiments, the gap 116 could be wider than or narrower than a thickness of at least one of the exterior panel 102 and the interior panel 104. During use, the insulating panel assembly 100 is arranged in a structure such as, for example, a commercial building, such that the exterior panel 102 faces an exterior of the building and the interior panel 104 faces an interior of the building. In various embodiments, the gap 116 may be filled with, for example, air. In other embodiments, the gap 116 may be filled with a gas such as, for example, argon or krypton. The gap 116 functions as a barrier to conductive heat transfer through the insulating panel assembly 100. In various embodiments, a width of the gap 116 may be adjusted in an effort to optimize insulating properties of the insulating panel assembly 100. In embodiments where a low-emissivity coating is applied to the interior panel 104, heat transfer across the insulating panel assembly 100 is improved. In such embodiments, the low emissivity coating is applied either to a first surface 106 of the interior panel 104 (commonly referred to as the “number 3 surface”) or a second surface 105 of the exterior panel 102 (commonly referred to as the “number 2 surface”). In various embodiments, however, the low emissivity coating may be applied to a second surface 108 of the interior panel 104 (commonly referred to as the “number 4 surface”).

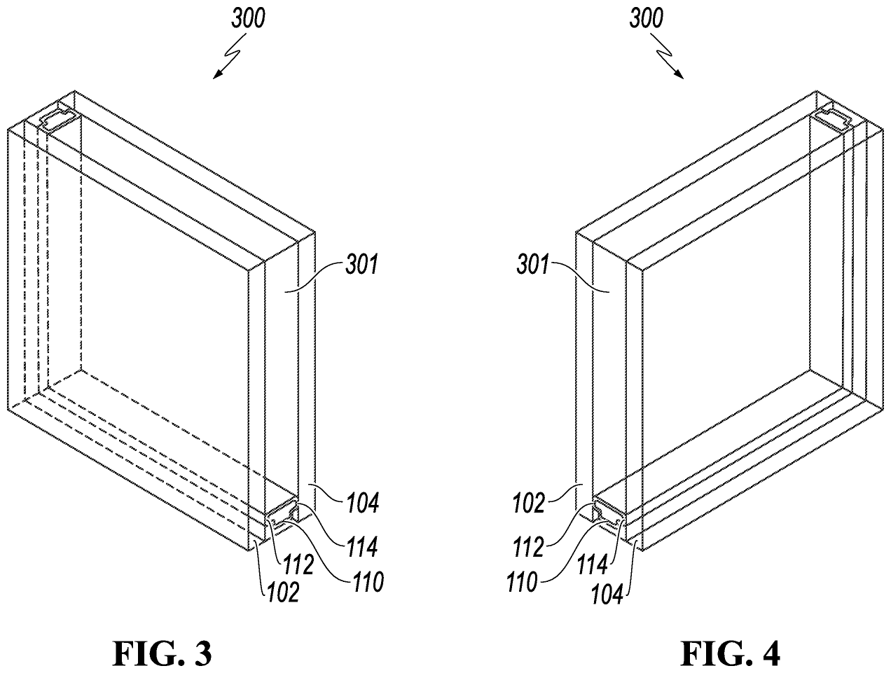

FIG. 3 is an exterior perspective view of an insulating panel assembly 300 with insulation 301. FIG. 4 is an interior perspective view of the insulating panel assembly 300. Referring to FIGS. 3-4 collectively, the insulating panel assembly 300 includes the exterior panel 102 and the interior panel 104. Insulation 301 is positioned between the exterior panel 102 and the interior panel 104. In various embodiments, the insulation 301 is solid insulation that is coupled to at least one of the exterior panel 102, the interior panel 104, and the spacer 110 via an adhesive applied to at least one of the exterior panel 102 and the interior panel 104. In such embodiments, the insulation 301 may be, for example, foam or any other type of solid insulation. In other embodiments, the insulation 301 could be free floating between the exterior panel 102 and the interior panel 104. In various other embodiments, the insulation 301 could be, for example, a liquid or a gel. During use, the insulating panel assembly 300 is arranged in a structure such as, for example, a commercial building, such that the exterior panel 102 faces an exterior of the building and the interior panel 104 faces an interior of the building. The insulation 301 functions as a barrier to conductive and convective heat transfer through the insulating panel assembly 300. Additionally, in embodiments, where the exterior panel 102 is constructed of a metal, heat transfer via radiation could be reduced by reflection of the radiation from the exterior panel 102; however, the amount of reflection varies with a finish applied to the exterior panel 102.

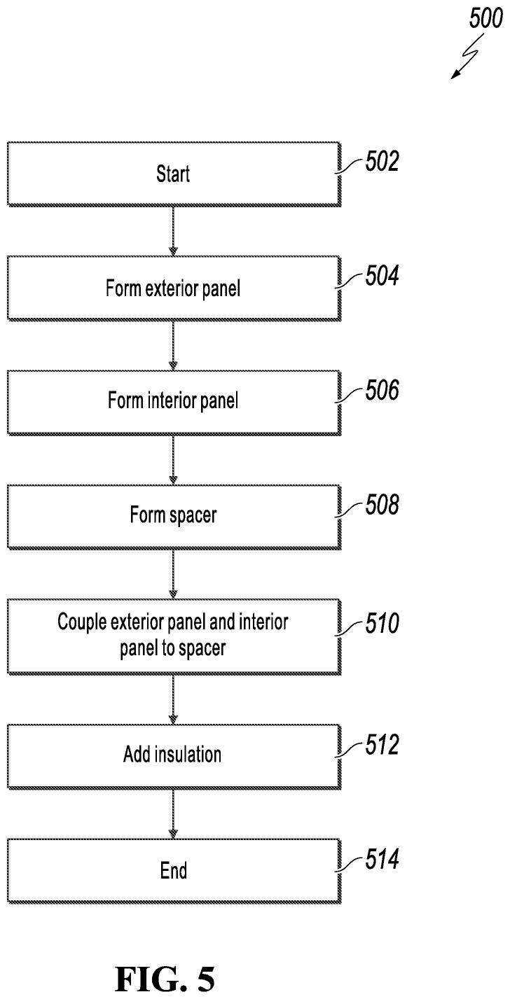

FIG. 5 is a flow diagram illustrating a process 500 for manufacturing an insulating panel assembly. The process 500 begins at step 502. At step 504, the exterior panel 102 and the interior panel 104 are coupled to the first attachment surface 112 and the second attachment surface 114 of the spacer 110, respectively. In various embodiments, the exterior panel 102 may be coupled to the first attachment surface 112 via an adhesive or with the use of mechanical fasteners such as, for example, screws, bolts, rivets, or other similar fasteners. Similarly, the interior panel 104 may be coupled to the second attachment surface 114 via an adhesive or with the use of mechanical fasteners such as, for example, screws, bolts, rivets, or other similar fasteners. At step 506, the insulation 301 is added between the exterior panel 102 and the interior panel 104. In various embodiments, the insulation could include injecting chemical components into the gap 116 between the exterior panel 102 and the interior panel 104 such that the chemical components react on contact to form an insulating foam. In other embodiments, step 506 may include injecting a gas such as, for example, Argon or Krypton, into the gap 116. In still other embodiments, step 506 may be omitted. In still other embodiments, insulation may be added in step 506 before the exterior panel 102 and the interior panel 104 are coupled to the spacer 110 in step 502. In such embodiments, the insulation could be coupled to at least one of the exterior panel 102, the interior panel 104, and the spacer 110 via, for example, an adhesive. The process 500 ends at step 508.

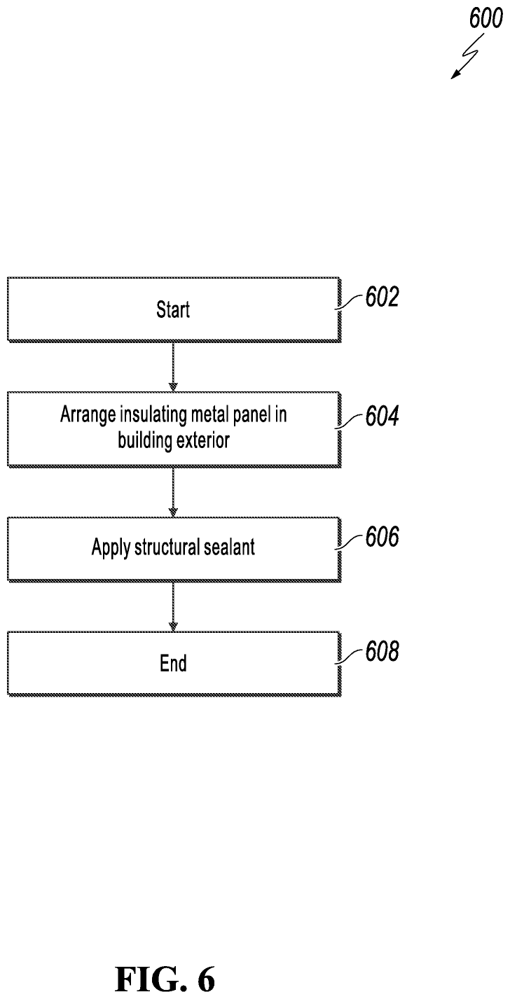

FIG. 6 is a flow diagram of a process 600 for installing an insulated metal panel. The process 600 begins at step 602. At step 604, the insulated metal panel is arranged in a building exterior. In various embodiments, the insulated metal panel could be, for example, the insulating panel assembly 100 or the insulating panel assembly 300 discussed above. The insulated metal panel is arranged such that the exterior panel 102 faces an exterior of the building and the interior panel 104 faces an interior of the building. At step 606, a structural sealant is applied to the interior panel 104. In various embodiments, the structural sealant may be, for example, structural silicone or other appropriate sealant. The process 600 ends at step 608.

In various embodiments, because the insulating panel assembly 100 and the insulating panel assembly 300 include the exterior panel 102 and the interior panel 104 that are secured to the spacer 110, and are not laminated to a centrally-located insulator, the insulating panel assembly 100 is not at risk of delamination of the exterior panel 102 or the interior panel 104. Further, the insulating panel assembly 100 and the insulating panel assembly 300 do not require any additional edge treatment to be aesthetically acceptable or to prevent delamination. Omission of edge treatment represents a reduction of production time and costs. Additionally, use of glass facilitates the insulating panel assembly 100 and the insulating panel assembly 300 being resistant to buckling.

Additionally, IMPs often include a foam core within a metal envelope. In contrast, the exterior panel 102 may, in various embodiments, be a solid metal sheet and, as such, provide improved support in structural applications over a foam envelope. Further, by manufacturing the exterior panel 102 of metal, and thereby orienting such a metal panel towards an exterior of a building, the insulating panel assembly 100 and the insulating panel assembly 300 exhibit improved utility in structural silicone glazing (“SSG”) applications because the silicone will be adhered to the interior panel 104, which is commonly made of glass. In such applications using currently-available IMPs, the structural silicone is applied to a metal panel which causes critical adhesion strength to vary based up on the metal finish. Finally, the exterior panel 102, commonly manufactured of metal, extends the full width and height of the insulating panel assembly 100 and the insulating panel assembly 300. Such an arrangement allows the insulating panel assembly 100 and the insulating panel assembly 300 to be assembled using traditional insulated glass assembly processes and equipment.

Although various embodiments of the method and system of the present disclosure have been illustrated in the accompanying Drawings and described in the foregoing Specification, it will be understood that the disclosure is not limited to the embodiments disclosed, but is capable of numerous rearrangements, modifications, and substitutions without departing from the spirit and scope of the disclosure as set forth herein. It is intended that the Specification and examples be considered as illustrative only.

What is claimed is:

1. An insulating panel assembly comprising:
an exterior panel, the exterior panel being formed of a metal;
an interior panel, the interior panel having a length equal to the exterior panel; and
a spacer coupled to the exterior panel and the interior panel, the spacer maintaining the exterior panel in a generally parallel, spaced relationship with the interior panel such that a gap is defined between the exterior panel and the interior panel.

2. The insulating panel assembly of claim 1, comprising an insulation disposed in the gap.

3. The insulating panel assembly of claim 2, wherein the insulation is free floating.

4. The insulating panel assembly of claim 2, wherein the insulation is coupled to at least one of the exterior panel, the interior panel, and the spacer.

5. The insulating panel assembly of claim 1, comprising a gas disposed in the gap.

6. The insulating panel assembly of claim 5, wherein the gas is at least one of air, Argon, and Krypton.

7. The insulating panel assembly of claim 1, wherein the interior panel is formed from an architectural glass.

8. The insulating panel assembly of claim 7, wherein the architectural glass is at least one of laminated glass and patterned decorative glass.

9. The insulating panel assembly of claim 1, comprising a low emissivity coating applied to at least one of the interior panel and the exterior panel.

10. The insulating panel assembly of claim 1, wherein reflectance of the exterior panel facilitates thermal insulation of the insulating panel assembly.

11. The insulating panel assembly of claim 1, wherein the interior panel imparts rigidity to the insulating panel assembly.

12. A method of manufacturing an insulating panel assembly, the method comprising:
forming an exterior panel from a metal;
forming an interior panel, the interior panel having a length equal to the exterior panel; and
coupling the exterior panel and the interior panel to a spacer such that a gap is defined between the exterior panel and the interior panel and the exterior panel and the interior panel are maintained in a generally parallel, spaced relationship.

13. The method of claim 12, comprising locating insulation within the gap.

14. The method of claim 13, wherein the insulation is free floating.

15. The method of claim 13, wherein the interior panel and the exterior panel are not laminated to the insulation.

16. The method of claim 12, wherein the interior panel and the exterior panel do not require edge treatment.

17. The method of claim 12, wherein, when installed, structural silicone is applied to the interior panel.

18. The method of claim 12, wherein a gas is disposed in the gap.

19. The method of claim 12, comprising applying a low-emissivity coating to at least one of the exterior panel and the interior panel.

20. The method of claim 12, wherein the interior panel is formed from an architectural glass.
